(19) United States
(12) Patent Application Publication
(10) Pub. No.: US 2014/0060687 A1
(43) Pub. Date: Mar. 6, 2014

(54) FAUCET

(71) Applicant: KLOD COHEN, ZEFAT (IL)

(72) Inventor: KLOD COHEN, ZEFAT (IL)

(21) Appl. No.: 13/706,368

(22) Filed: Dec. 6, 2012

(30) Foreign Application Priority Data
Sep. 4, 2012 (IL) 221766

(51) Int. Cl. E03C 1/02

(52) U.S. Cl. CPC E03C 1/02
USPC 137/801

(57) ABSTRACT

In one aspect, the present invention is directed to a faucet (10), comprising: a gearbox having an engaged state in which a handle (24) of the faucet is engaged to a valve (36) of the faucet, and a disengaged state in which the handle (24) is disengaged from the valve (36); wherein the gearbox is adapted to turn to the engaged state by pressing the handle towards the valve, and to turn to the disengaged state otherwise; thereby preventing unintentional turning on/off of the faucet, resulting in not putting a user thereof in jeopardy.

### FIELD OF THE INVENTION

The present invention relates to the field of faucets, including domestic water faucets.

### BACKGROUND OF THE INVENTION

A faucet is a valve for controlling a release of liquids or gas. Indoor faucets are commonly found in domestic bathrooms and kitchens.

Water for baths, sinks and basins can be provided by separate hot and cold faucets. This arrangement is common in older installations, particularly in public washrooms and utility rooms. In kitchens and bathrooms, mixer faucets are commonly used. In this case, hot and cold water from the two valves is mixed before reaching the outlet, allowing the water to emerge at any temperature between that of the hot and cold water supplies.

It may not be immediately clear which faucet is for the hot water and which is for the cold. The hot faucet usually has a red indicator, while the cold faucet usually has a blue or green indicator. In the United States, the faucets are frequently also labeled with an “H” for hot, and “C” for cold. But in countries with Romance languages, such as France or Italy, the letter “C” is used for hot, and “F” is used for cold. (In French, “C” stands for “chaud”, meaning hot, and “F” stands for “froid”, meaning cold; and in Italian “C” stands for “caldo”, meaning hot, while “F” stands for “freddo”, meaning cold). This can create confusion when English speakers visit these countries, or vice versa.

In most countries, there is a standard arrangement for hot and cold faucets. For example, in the United States and many other countries, the hot faucet is on the left due to building code requirements. However, many installations exist in which this standard has been ignored (called “crossed connections” by plumbers).

Due to distraction of mind or unintentional action, people sometimes open a hot water faucet while the spout is directed towards them, and get severe burns from the hot water. The water from the faucet can be very hot, and an unintentional opening of a hot tap can even cause bad injuries to babies, when a parent washes a baby. A child who is showered by a parent, may sometime play with the faucet without the parent noticing it, resulting in opening the hot water, which could result in the child suffering a burn. Also, a similar problem may happen with the cold water tap: in cold countries, an unintentional opening of the cold water may result in a very unpleasant experience, especially if it happens to a baby or a small child.

All the faucet devices of the prior art have not yet provided satisfactory solutions to the problem of preventing unintentional opening/closing of a faucet.

It is an object of the present invention to provide a solution to the above-mentioned and other problems of the prior art.

Other objects and advantages of the invention will become apparent as the description proceeds.

### SUMMARY OF THE INVENTION

In one aspect, the present invention is directed to a faucet (10), comprising:
a gearbox having an engaged state in which a handle (24) of the faucet is engaged to a valve (36) of the faucet, and a disengaged state in which the handle (24) is disengaged from the valve (36);
wherein the gearbox is adapted to turn to the engaged state by pressing the handle towards the valve, and to turn to the disengaged state otherwise;
   thereby preventing unintentional turning on/off of the faucet, resulting in not putting a user thereof in jeopardy.

According to one embodiment of the invention, the gearbox comprises:
a first cogwheel (32), engaged to the valve (36);
a second cogwheel (26), engaged to the handle (24), wherein the first cogwheel (32) corresponds to the second cogwheel (26); and
a spring (28) for separating the second cogwheel (26) from the first cogwheel (32), thereby situating the faucet in the disengaged state.

According to one embodiment of the invention, the second cogwheel (26) is slideable along the axle (30).

According to one embodiment of the invention, the handle is implemented as a knob.

In another aspect, the present invention is directed to a faucet system, comprising a safety mechanism for the hot water faucet, and a safety mechanism for the cold water faucet, the strength of a spring of a hot water faucet being greater than the strength of a spring of a cold water faucet, thereby requiring additional force for turning the hot water faucet than the force of turning the cold water faucet.

In yet another aspect, the present invention is directed to a faucet system having a hot water faucet and a cold water faucet, wherein only the hot water faucet uses the safety mechanism.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF THE DRAWINGS

Embodiments and features of the present invention are described herein in conjunction with the following drawings:

FIG. 1 schematically illustrates a faucet system, according to one embodiment of the invention.

FIG. 2 schematically illustrates the hot-water faucet of FIG. 1, in an engaged state thereof.

FIG. 3 is an exploded view of the cold/hot water faucet of FIG. 1.

FIG. 4a is a cross-section of a faucet in the disengaged state thereof, according to one embodiment of the invention.

FIG. 4b is a cross-section of the engaged state thereof.

It should be understood that the drawings are not necessarily drawn to scale.

### DETAILED DESCRIPTION OF THE INVENTION

The present invention will be understood from the following detailed description of preferred embodiments, which are meant to be descriptive and not limiting. For the sake of brevity, some well-known features, methods, systems, procedures, components, circuits, and so on, are not described in detail.

The present invention is directed to a faucet which prevents unintentional turning on/off, thereby providing safe operation. The safe operation is achieved by employing a gearbox between the handle of the faucet and the valve of the faucet. The gearbox comprises two states: an “engaged state”, and a “disengaged state”, which is the default state.

In order to situate the faucet in its engaged state, a user has to push the handle towards the valve, thereby causing the separated parts of the transmission of the gearbox to get engaged. In this situation, rotating the handle causes rotation of the valve. Upon releasing the handle, the gearbox returns to its disengaged state.

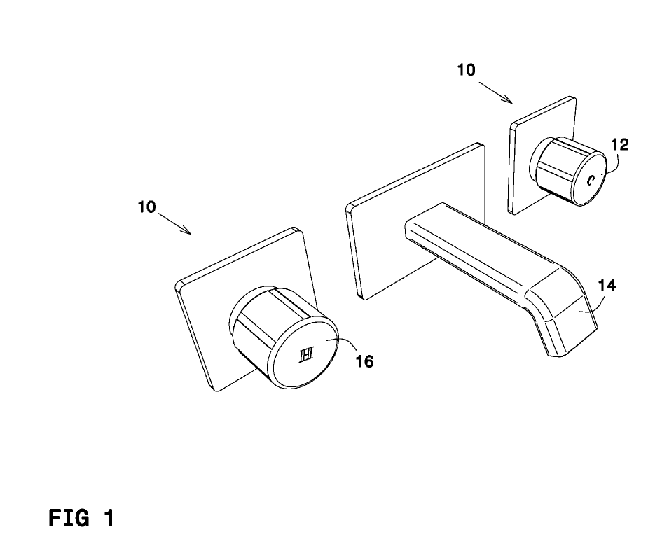

FIG. 1 schematically illustrates a faucet system, according to one embodiment of the invention.

According to this embodiment, a safety mechanism for opening a water tap is installed inside each of the faucets 10 of the faucet system.

It should be noted that a similar mechanism can be installed in other faucet configurations, such as a single-handle double-spout faucet (one spout for hot, one spout for cold), single-handle single-spout faucet, etc. The safety faucet can also replace an existing faucet.

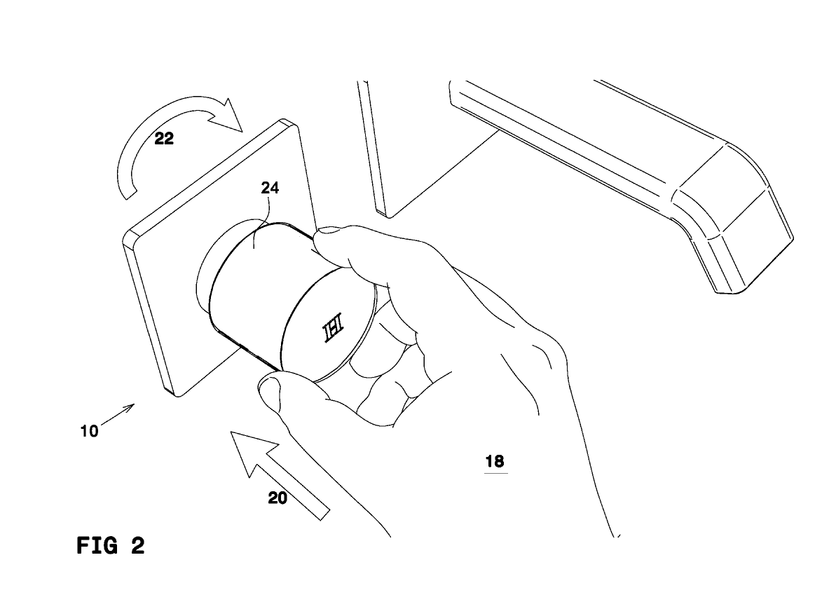

FIG. 2 schematically illustrates the hot-water faucet of FIG. 1, in an engaged state thereof.

According to this embodiment of the invention, handle 24 can be in one of two different states: an engaged state in which turning handle 24 of the faucet results in turning the valve of the faucet (not seen in this figure), and a disengaged state, in which turning the handle does not have any influence on the faucet.

Situating the faucet in its engaged state is carried out by pressing the faucet in the direction of arrow 20 by a user hand 18. In this situation, a rotation of handle (knob) 24 results in rotating the valve of the faucet. The rotation is marked herein by arrow 22.

Leaving the handle up puts the faucet in its disengaged state. Thus, the disengaged state is the default state of the faucet.

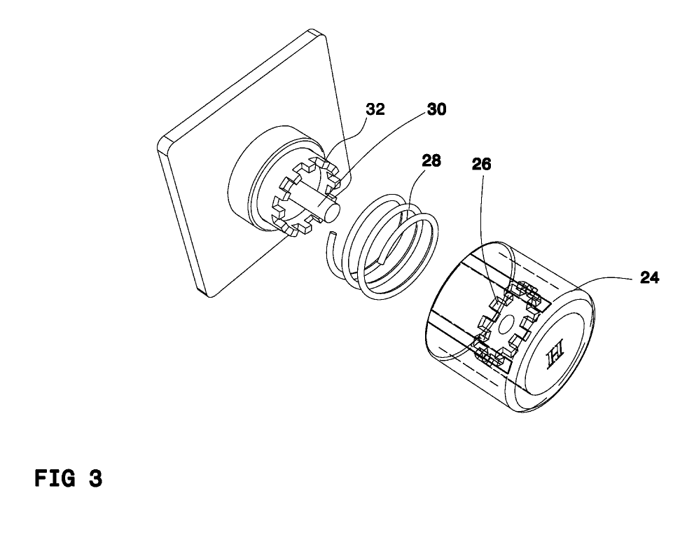

FIG. 3 is an exploded view of the cold/hot water faucet of FIG. 1. For illustration purpose, handle 24 is transparent.

The mechanism comprises: a first cogwheel 32, engaged to axle 30 of a valve of the faucet; a second cogwheel 26 engaged to handle 24; and a spring 28, for keeping the cogwheels separated while the mechanism is in its disengaged state, which is the default state thereof.

While handle 24 is not pushed in an inward direction 20, spring 28 keeps the cogwheels disengaged, allowing the handle to freely slide on the axle without affecting the valve of the faucet.

In order to open the valve, a user must push handle 24 in an inward direction (reference numeral 20 in FIG. 2). Only while the user pushes handle 24 in the inward direction, the cogwheels are engaged, and the operation of turning the valve on/off is effective.

While the user pushes the handle 24, the force operated on the handle overcomes the force of spring 28. The inwards movement of handle 24 with the compression of spring 28 approximates second cogwheel 26 to first cogwheel 32, until engaged.

It should be noted that according to another embodiment of the invention, first cogwheel 32 and second cogwheel 26 can be replaced by a male member and a female member. A cogwheel has a plurality of male members subsequent to female members.

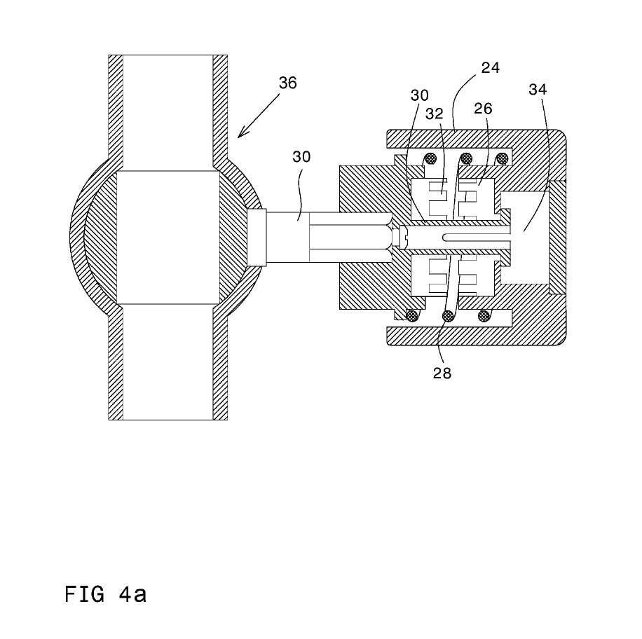

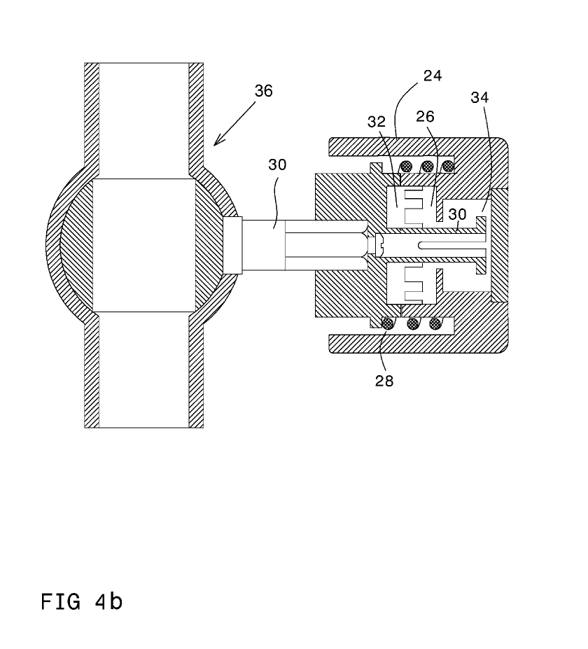

FIG. 4a is a cross-section of a faucet in the disengaged state thereof, according to one embodiment of the invention. FIG. 4b is a cross-section of the engaged state thereof.

Cogwheel 26 is “permanently” engaged to handle 24. Cogwheel 32 is “permanently” engaged to axle 30, which closes/opens valve 36. However, the cogwheels 32 and 26 are disengaged in FIG. 4a, and engaged in FIG. 4b. In order to engage the cogwheels, a user must push handle 24 to which cogwheel 26 is engaged, towards axle 30 to which cogwheel 32 is engaged, until the cogwheels get engaged. In this situation, turning handle 24 results in turning axle 30, which turns valve 36.

In these figures, space 34 enables axle 30 to enter therein, thereby allowing handle 24 to slide over axle 30.

The safety mechanism can be used only for hot water in a faucet system having hot and cold water, as the hot water is the water that puts a user in jeopardy.

Furthermore, in a faucet system having hot and cold water, the spring strength of the hot water faucet may be stronger than the spring of the cold water faucet, as the hot water is the water that puts a user in jeopardy.

In the figures and/or description herein, the following reference numerals have been mentioned:
numeral 10 denotes a faucet, according to one embodiment of the invention;
numeral 12 denotes a cold water handle;
numeral 14 denotes a spout (nozzle);
numeral 16 denotes a hot water handle;
numeral 18 denotes a hand of a user;
numeral 20 denotes pushing the handle (24) in an inward direction;
numeral 22 denotes turning the handle (24) in a clockwise direction;
numeral 24 denotes a handle of the faucet;
numeral 26 denotes a second cogwheel;
numeral 28 denotes a spring;
numeral 30 denotes an axle;
numeral 32 denotes a first cogwheel;
numeral 34 denotes a space; and
numeral 36 denotes a valve of said faucet.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

What is claimed is:

1. A faucet (10), comprising:
a gearbox having an engaged state in which a handle (24) of said faucet is engaged to a valve (36) of said faucet, and a disengaged state in which said handle (24) is disengaged from said valve (36);
wherein said gearbox is adapted to turn to said engaged state by pressing said handle towards said valve, and to turn to said disengaged state otherwise;
thereby preventing unintentional turning on/off of said faucet, resulting in not putting a user thereof in jeopardy.

2. A faucet according to claim 1, wherein said gearbox comprises:
a first cogwheel (32), engaged to said valve (36);
a second cogwheel (26), engaged to said handle (24), wherein said first cogwheel (32) corresponds to said second cogwheel (26); and
a spring (28) for separating said second cogwheel (26) from said first cogwheel (32), thereby situating said faucet in said disengaged state.

3. A faucet according to claim 1, wherein said second cogwheel (26) is slideable along said axle (30).

4. A faucet according to claim 1, wherein said handle is implemented as a knob.

5. A faucet system, comprising a hot water faucet according to claim 1 and a cold water faucet according to claim 1, wherein a strength of a spring of a hot water faucet is greater than a strength of a spring of a cold water faucet, thereby requiring additional force for turning said hot water faucet than the force of turning said cold water faucet.

6. A faucet system having a hot water faucet and a cold water faucet, wherein only said hot water faucet uses said safety mechanism according to claim 1.
